(19) United States
(12) Patent Application Publication
(10) Pub. No.: US 2008/0157683 A1
(43) Pub. Date: Jul. 3, 2008

(54) VACUUM FLUORESCENT DISPLAY AND FILAMENT DRIVING METHOD THEREOF

(75) Inventors: Chun-Hsiung Chen, Hsinchu (TW); Wen-Liang Liu, Hsinchu (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: HOLTEK SEMICONDUCTOR INC., Hsinchu (TW)

(21) Appl. No.: 11/842,579

(22) Filed: Aug. 21, 2007

(30) Foreign Application Priority Data
Dec. 27, 2006 (TW) 095149322

(51) Int. Cl. G09G 3/10

(52) U.S. Cl. 315/169.1

(57) ABSTRACT

A vacuum fluorescent display (VFD) and a filament-driving method are provided. Two sub-dc voltages having peaks respectively interlaced with each other on the waveform thereof are used to drive the filament. A driving circuit is integrated in the integrated circuit of a VFD driver, a VFD controller or a VFD MCU. The VFD is able to operate without utilizing a transformer.

### FIELD OF THE INVENTION

The present invention relates to a vacuum fluorescent display and filament driving method thereof, and more particularly to a vacuum fluorescent display with a filament driven by dc power.

### BACKGROUND OF THE INVENTION

Vacuum fluorescent display (VFD) is commonly utilized in the application of a small display to provide a better contrast of brightness. VFD has the advantages of better brightness, wider visual angle, larger operating temperature range and lower production cost.

A VFD is generally composed of three electrodes, i.e. a cathode, an anode and a grid. The cathode is a filament of the VFD, the anode is a phosphor, and the grid is a metal film for controlling and diffusing the electric charges ejected from the cathode.

The type of the filament in a VFD depends upon the filament driving method thereof. There are usually two kinds of filament driving methods, i.e. an ac power driving method and a dc power driving method.

Please refer to FIG. 1, which is a block diagram showing a conventional vacuum fluorescent display according to the prior art. In FIG. 1, a vacuum fluorescent display 1 comprises a panel 10, an anode-and-grid control device 11 and a transformer 12. The panel 10 further comprises at least a filament 101 therein.

In the vacuum fluorescent display 1, an ac power is firstly transformed into a filament voltage by the transformer 12. A filament voltage signal is then generated from the filament voltage and finally transmitted to two ends F1 & F2 of the filament 101 so that the filament 101 luminesces. Besides, an anode signal and a grid signal are generated by the anode-and-grid control device 11 and then transmitted to the panel 10 to decide which points on the panel 10 must luminesce.

In the conventional VFD 1, the high ac power is necessarily to be transformed into the low filament voltage for the filament 101 of the VFD 1 (as shown in the waveform diagram of FIG. 2) by the transformer 12, so that the filament 101 is driven by the AC power. However, the ac power driving method utilizing a transformer will increase the cost as well as the circuit board area of the VFD.

Therefore, for decreasing the cost, it is necessary to provide a driving method to drive the filament in the VFD with a dc voltage, so that the filament of the VFD luminesces without utilizing a transformer.

### SUMMARY OF THE INVENTION

It is therefore an object of the present invention to provide a vacuum fluorescent display (VFD) and a filament-driving method. Two sub-dc voltages having peaks respectively interlaced with each other on the waveform thereof are used to drive the filament. A driving circuit is integrated in the integrated circuit of a VFD driver, a VFD controller or a VFD MCU. The VFD is able to operate without utilizing a transformer.

According to the foregoing object of the present invention, a vacuum fluorescent display (VFD) is provided. The VFD comprises a panel having at least a filament, and an anode-and-grid control device electrically connected to two ends of the filament to generate a dc signal to light the panel. The filament is controlled by the dc signal, the dc signal comprises two sub-signals respectively transmitted to the two ends of the filament, and one of the sub-signals comprises a waveform whose peaks are interlaced with those of the other.

According to the foregoing object of the present invention, a filament driving method for a vacuum fluorescent display (VFD) comprising a panel having at least a filament and an anode-and-grid control device is provided. The driving method comprises steps of: providing an anode signal, a grid signal and a dc signal by the anode-and-grid control device to the panel, wherein the dc signal comprises two sub-signals respectively transmitted to two ends of the filament, and one of the sub-signals comprises a waveform whose peaks are interlaced with those of the other, and controlling the filament with the dc signal in order to light up the panel in cooperation with the anode signal and the grid signal.

The foregoing and other features and advantages of the present invention will be more clearly understood through the following descriptions with reference to the drawings, wherein:

### BRIEF DESCRIPTION OF THE DRAWINGS

FIG. 1 is a block diagram showing a conventional vacuum fluorescent display according to the prior art;

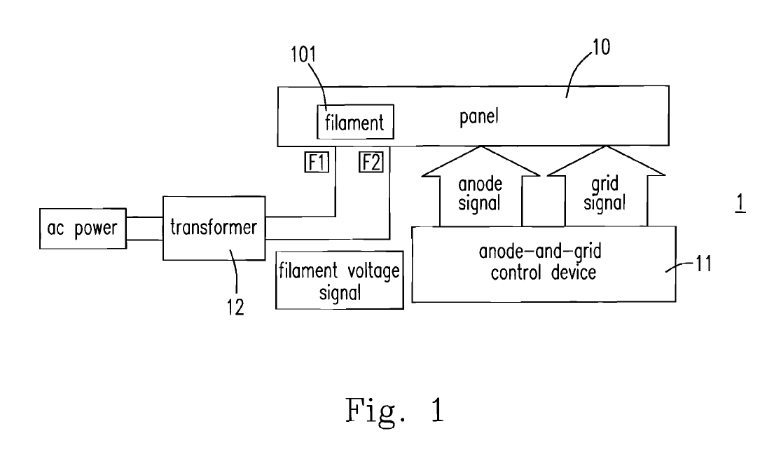

FIG. 2 is a waveform diagram showing the voltage across the filament shown in FIG. 1;

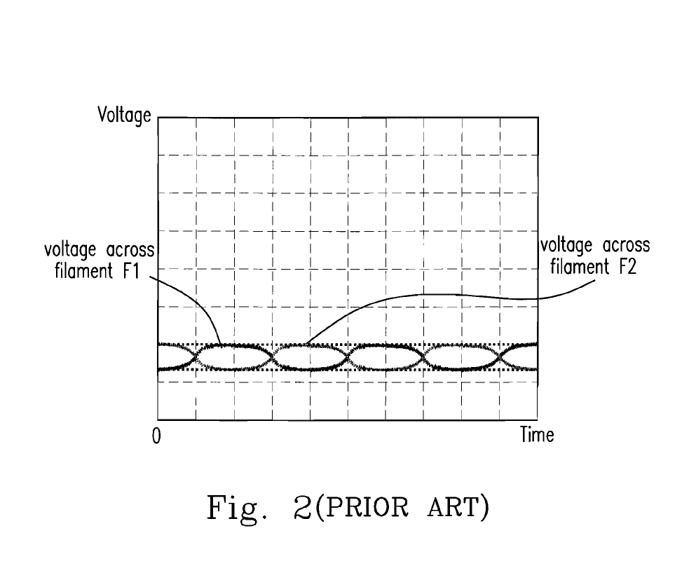

FIG. 3 is a block diagram showing a vacuum fluorescent display according to the present invention; and

FIG. 4 is a waveform diagram showing the voltage across the filament shown in FIG. 3.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

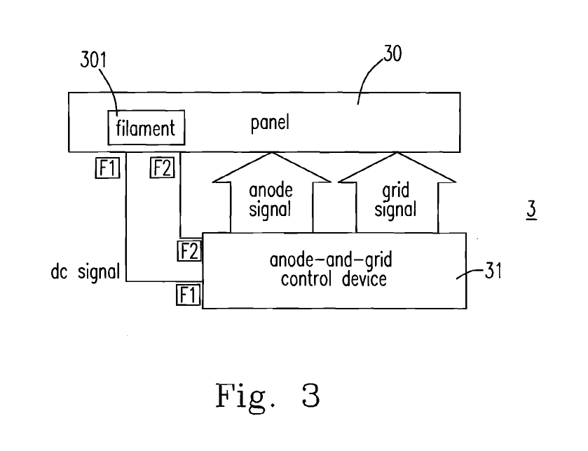

Please refer to FIG. 3, which is a block diagram showing a vacuum fluorescent display according to the present invention. In FIG. 3, a vacuum fluorescent display 3 comprises a panel 30 and an anode-and-grid control device 31. The panel 30 further comprises at least a filament 301 therein. The anode-and-grid control device 31 can be a VFD driver, a VFD controller or a VFD microprocessor control unit (MCU).

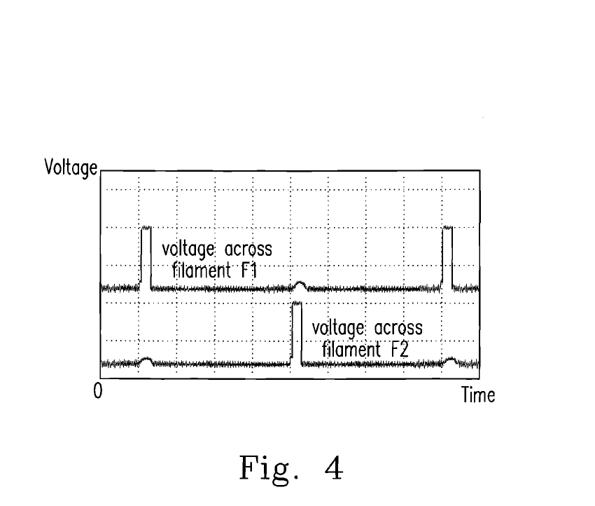

In order to omit the utilizing of the transformer, the two output pins F1 & F2 of the anode-and-grid control device 31 are electrically connected to the two ends of the filament 301 of the VFD 3. As mentioned previously, the anode-and-grid control device 31 may be a VFD driver, a VFD controller or a VFD microprocessor control unit (MCU). Two sub-dc signals are repetitively input into the two output pins F1 & F2. In detailed, as shown in FIG. 4, one of the sub-dc signals input into the pin F1 is with peaks respectively interlaced with those of the other sub-dc signal input into the pin F2 on the waveforms thereof. With the cooperation of the grid signal and the anode signal for the VFD 3, the panel 30 will luminesce.

Similar to the prior art, the anode signal and the grid signal are generated by the anode-and-grid control device 31 and then transmitted to the panel 30 to decide which points on the panel 30 must luminesce.

The filament 301 of the VFD 3 according to the present invention is driven by the dc signal, and the driving voltage for the filament 301 is provided by a VFD driver, a VFD controller or a VFD MCU. Therefore, the filament 301 of the present VFD 3 is able to luminesce without utilizing a transformer.

In conclusion, with the VFD and the filament driving method thereof, the filament of the VFD can be driven by a dc power, so that the filament of the panel luminesces without utilizing a transformer. The production cost and the circuit board area of the VFD can thus be decreased.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A vacuum fluorescent display (VFD), comprising:
a panel having at least a filament with two ends; and
an anode-and-grid control device electrically connected to the two ends of the filament to generate an anode signal, a grid signal and a dc signal;
wherein the filament is controlled by the dc signal to light the panel in cooperation with the anode signal and the grid signal, the dc signal comprises two sub-signals respectively transmitted to the two ends of the filament, and one of the sub-signals comprises a waveform whose peaks are interlaced with those of the other.

2. The VFD as claimed in claim 1, wherein the anode-and-grid control device comprises a VFD driver.

3. The VFD as claimed in claim 1, wherein the anode-and-grid control device comprises a VFD controller.

4. The VFD as claimed in claim 1, wherein the anode-and-grid control device comprises a VFD microprocessor control unit (MCU).

5. A vacuum fluorescent display (VFD), comprising:
a panel having at least a filament with two ends; and
an anode-and-grid control device electrically connected to the two ends of the filament to generate a dc signal to light the panel;
wherein the filament is controlled by the dc signal, the dc signal comprises two sub-signals respectively transmitted to the two ends of the filament, and one of the sub-signals comprises a waveform whose peaks are interlaced with those of the other.

6. The VFD as claimed in claim 5, wherein the anode-and-grid control device comprises a VFD driver.

7. The VFD as claimed in claim 5, wherein the anode-and-grid control device comprises a VFD controller.

8. The VFD as claimed in claim 5, wherein the anode-and-grid control device comprises a VFD microprocessor control unit (MCU).

9. A filament driving method for a vacuum fluorescent display (VFD) comprising a panel having at least a filament and an anode-and-grid control device, comprising steps of:
providing an anode signal, a grid signal and a dc signal by the anode-and-grid control device to the panel, wherein the dc signal comprises two sub-signals respectively transmitted to two ends of the filament, and one of the sub-signals comprises a waveform whose peaks are interlaced with those of the other; and
controlling the filament with the dc signal in order to light up the panel in cooperation with the anode signal and the grid signal.
